(19) United States
(12) Patent Application Publication
(10) Pub. No.: US 2025/0173458 A1
(43) Pub. Date: May 29, 2025

(54) SYSTEM AND METHOD FOR CONTROLLING ACCESS TO CONTENT ON AN ELECTRONIC DEVICE

(71) Applicant: Samsung Electronics Co., Ltd., Suwon-si (KR)

(72) Inventors: Lahar GUPTA, Noida Uttar Pradesh (IN); Mangi Lal SHARMA, Noida Uttar Pradesh (IN); Deepanshu SHARMA, Noida Uttar Pradesh (IN); Dhwanit CHAUHAN, Noida Uttar Pradesh (IN); Yaswanth Kumar PAGIDIPALLI, Noida Uttar Pradesh (IN)

(21) Appl. No.: 18/917,221

(22) Filed: Oct. 16, 2024

Related U.S. Application Data
(63) Continuation of application No. PCT/KR2024/012243, filed on Aug. 16, 2024.

(30) Foreign Application Priority Data
Nov. 23, 2023 (IN) 202311079665

(51) Int. Cl. G06F 21/62

(52) U.S. Cl. CPC G06F 21/6245

(57) ABSTRACT

A method and system for controlling framework units for accessing content on an electronic device is described. The method comprises: capturing an interaction indicative of an interaction of a user with respect to each content type of the content; extracting a set of attribute values based on the content and the interaction, wherein the set of attribute values is indicative of user behaviour patterns with respect to each content type; classifying the content based on the extracted set of attributes values, wherein the classification determines the sensitivity of the content as either of interest or of non-interest; and controlling access to the content for one or more applications associated with the electronic device based on the classified content being one of interest or non-interest to the user.

### CROSS-REFERENCE TO RELATED APPLICATIONS

This application is a continuation of International Application No. PCT/KR2024/012243 designating the United States, filed on Aug. 16, 2024, in the Korean Intellectual Property Receiving Office and claiming priority to Indian Patent Application number 202311079665, filed on Nov. 23, 2023, in the Indian Patent Office, the disclosures of each of which are incorporate by reference herein in their entireties.

### BACKGROUND

### Field

The disclosure relates to content monitoring, and for example, relates to system and method for controlling access to content on an electronic device to restrict applications from accessing the content.

### Description of Related Art

In the digital age, users are making use of multiple applications in their electronic devices. In order to utilize the multiple applications, the users need to provide various permissions and enable different settings for the multiple applications on the electronic device. In a lot of cases, the permissions and settings allow the multiple applications to access user's data on the electronic device. That is, users face the challenge of managing multiple applications and their respective privacy settings to access the user's data on the electronic device.

With the permissions and settings, the applications can access and read personal and non-personal data of the user. Moreover, the applications can capture user interests when the users are interacting with various content through the electronic device. The users may not have intended to share data and interaction information with the applications, however, the applications can still access this data and interaction information knowingly or unknowingly. The data and information can then be shared with third-parties and accordingly targeted advertising can be provided. In addition, the data and information can also be sold to other parties.

Existing techniques include reporting about the privacy leaks by applications. Further, existing techniques include monitoring which applications are capturing and accessing user information and notifying the users if any applications use a permission that is especially important or outside their normal operating range. However, there is no mechanism for Original Equipment Manufacturers (OEMs) to auto control the access to the user's data. In case the user can given the permissions, then the applications can freely access user data anytime. Access of data is controlled based on static set of permissions. Moreover, existing techniques do not maintain privacy while users are interacting on content via the applications. As a result, user's interest information is easily leaked and privacy is breached.

Accordingly, there is a need for systems and methods that overcome at least some of the above-mentioned limitations.

### SUMMARY

According to an example embodiment of the present disclosure, a method for controlling framework units for accessing content on an electronic device is provided. The method comprises: capturing an interaction indicative of an interaction of a user with respect to each content type of the content; extracting a set of attribute values based on the content and the interaction, wherein the set of attribute values is indicative of user behaviour patterns with respect to each content type; classifying the content based on the extracted set of attributes values, wherein the classification determines a sensitivity of the content as either of interest or not of interest; controlling access to the content for one or more applications associated with the electronic device based on the classified content being one of interest or not of interest to the user.

According to an example embodiment of the present disclosure, a system for controlling framework units for accessing content on an electronic device is provided. The system comprises: a memory configured to store a plurality of modules comprising executable instructions and at least one processor, comprising processing circuitry, communicatively coupled to the memory, wherein at least one processor, individually and/or collectively, is configured to execute the executable instructions associated with the plurality of modules. The plurality of modules comprises: an interaction estimator module configured to capture an interaction indicative of an interaction of a user with respect to each content type of the content; an attribute extractor module configured to extract a set of attribute values based on the content and the interaction, wherein the set of attribute values is indicative of user behaviour patterns with respect to each content type; an interest estimator module configured to classify the content based on the extracted set of attributes values, wherein the classification determines the sensitivity of the content as either of interest or not of interest; and a privacy controller module configured to control access to the content for one or more applications associated with the electronic device based on the classified content being one of interest or not of interest to the user.

According to an example embodiment of the present disclosure, a method for dynamically restricting applications from accessing content in an electronic device is provided. The method comprises: capturing user interactions with content types, the captured user interactions forming user behavior patterns on the attributes indicative of responses of a user to each content type; training an on-device machine learning model based on the content types and captured interactions to extract attributes specific to the user; classifying content based on extracted attributes, wherein the classification determines the sensitivity of the content as either of interest or not of interest; capturing user behavior based on interacting with new content on the electronic device; predicting, using the trained on-device machine learning model, whether the interaction with new content resulting interest or not of interest to the user in content; and controlling access to the content by the applications on the electronic device.

To further illustrated the advantages and features of the present disclosure, a more particular description of various example embodiments will be rendered by reference to the drawings. It will be appreciated that these drawings depict only example embodiments and are therefore not to be considered limiting of its scope. The disclosure will be described and explained with additional specificity and detail with the accompanying drawings.

### BRIEF DESCRIPTION OF THE DRAWINGS

These and other features, aspects, and advantages of certain embodiments of the present will be more apparent from the following detailed description, taken in conjunction with the accompanying drawings in which like characters represent like parts throughout the drawings, an in which:

FIG. 1 is a block diagram illustrating an example environment comprising an electronic device and a system associated with the electronic device, according to various embodiments;

FIG. 2 is a block diagram illustrating an example configuration of the system, according to various embodiments;

FIG. 3 is a block diagram illustrating example operational flow associated with determining optimal interaction, according to various embodiments;

FIG. 4A is a block diagram illustrating example operational flow associated with extracting a set of attributes, according to various embodiments;

FIGS. 4B and 4C illustrates an example set of attribute values extracted by an attribute extractor, according to various embodiments;

FIG. 5 is a block diagram illustrating example operational flow associated with classifying content, according to various embodiments;

FIG. 6 is a block diagram illustrating example hybrid model deployment, according to various embodiments;

FIG. 7 is a block diagram illustrating example operational flow associated with controlling access to the content, according to various embodiments;

FIG. 8 is a flowchart illustrating an example method for controlling framework units to access content on the electronic device, according to various embodiments;

FIG. 9 is a flowchart illustrating an example method for dynamically restricting applications from accessing content on the electronic device, according to various embodiments; and

FIGS. 10, 11, 12 and 13 are diagrams illustrating various example use case scenarios for the system to control access to the content, according to various embodiments.

Further, skilled artisans will appreciate that elements in the drawings are illustrated for simplicity and may not have necessarily been drawn to scale. For example, the flowcharts illustrate an example method in terms of the steps involved to help to improve understanding of aspects of the present disclosure. Furthermore, in terms of the construction of the device, one or more components of the device may have been represented in the drawings by conventional symbols, and the drawings may show details that are pertinent to understanding the various embodiments of the present disclosure so as not to obscure the drawings with details that will be readily apparent to those of ordinary skill in the art having the benefit of the description herein.

### DETAILED DESCRIPTION

Reference will now be made to the various example embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this disclosure to “an aspect”, “another aspect” or similar language may refer, for example, to a particular feature, structure, or characteristic described in connection with an embodiment being included in at least one embodiment of the present disclosure. Thus, appearances of the phrase “in an embodiment”, “in another embodiment” and similar language throughout this disclosure may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

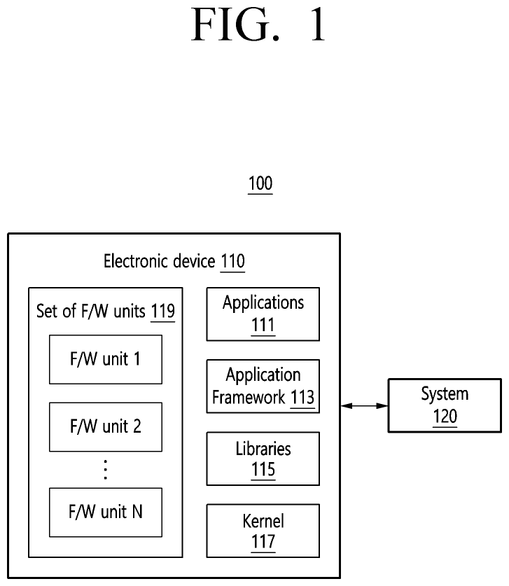

FIG. 1 is a block diagram illustrating an example overview of an environment 100 comprising an electronic device 110 and a system 120 associated with the electronic device 110 according to various embodiments. The system 120 may be communicably coupled to the electronic device 110. In an embodiment, the system 120 may be integrated within the electronic device 110. In an embodiment, the system 120 may be provided in a distributed manner, in that, one or more components of the system 120 may be provided on the electronic device 110 and one or more components of the system 120 may be provided on a remote cloud-based unit.

The electronic device 110 may include one or more applications 111, an application framework 113, libraries 115, kernel 117, and a set of framework units 119 (framework unit 1, framework unit 2, . . . framework unit N). The one or more applications 111 may include software applications (e.g., including executable program instructions) downloadable from, for example, the internet or pre-installed in the electronic device 110. The electronic device 110 may further include a user interface and hardware buttons. The set of framework units 119 may refer to monitoring services running in conjunction with the one or more applications 111 and/or the electronic device 110. In an embodiment, the monitoring services may include a first monitoring service running in conjunction with the one or more applications 111 to monitor user interactions and a second monitoring service running in conjunction with the electronic device 110 to monitor user interactions. Further, details regarding the application framework 113, the libraries 115, the kernel 117, and the set of framework units 119 have not be provided here for the sake of brevity.

In non-limiting examples, the electronic device 110 may include, for example, and without limitation, a mobile device, a smart watch, a tablet, a smart television, wearable controllers, laptops, Augmented Reality (AR) headsets, Virtual Reality (VR) headsets, and the like.

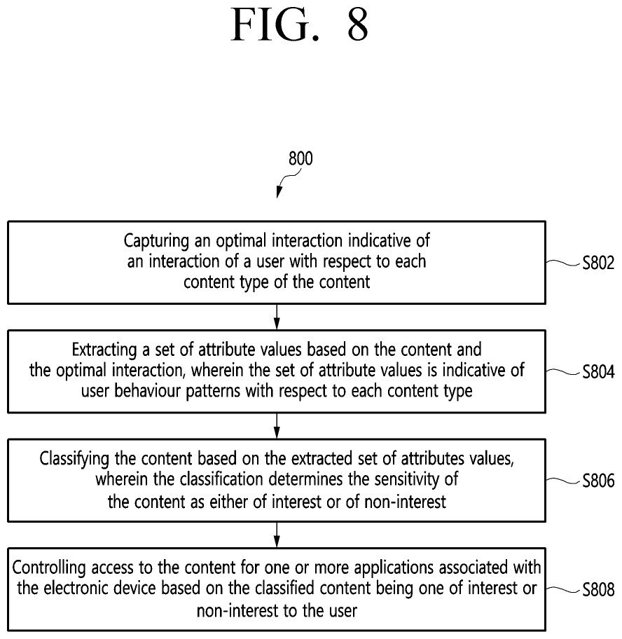

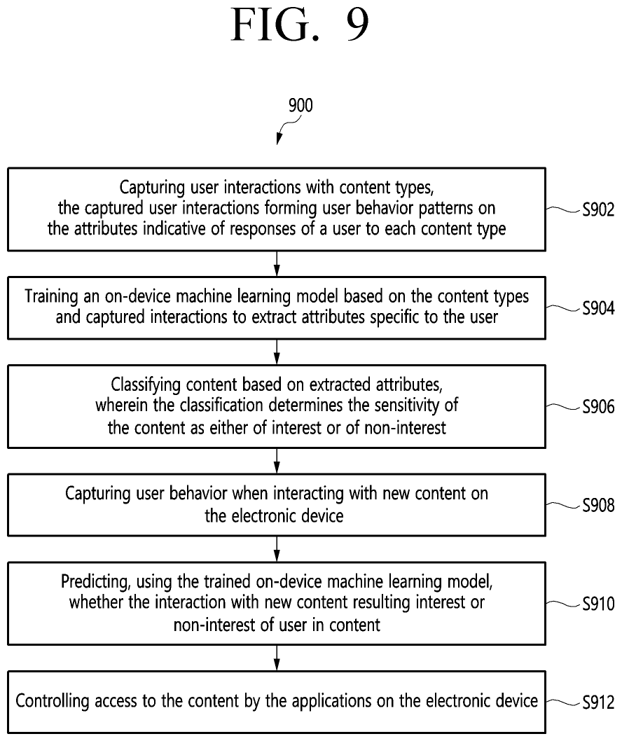

The system 120 may be configured for controlling the set of framework units for accessing content on the electronic device 110. In an embodiment, the system 120 may be integrated within the application framework 113. The system 120 may be configured to perform operations and achieve the technical advantages by performing one or more operations as explained in greater detail below at least with reference to FIGS. 8 and 9.

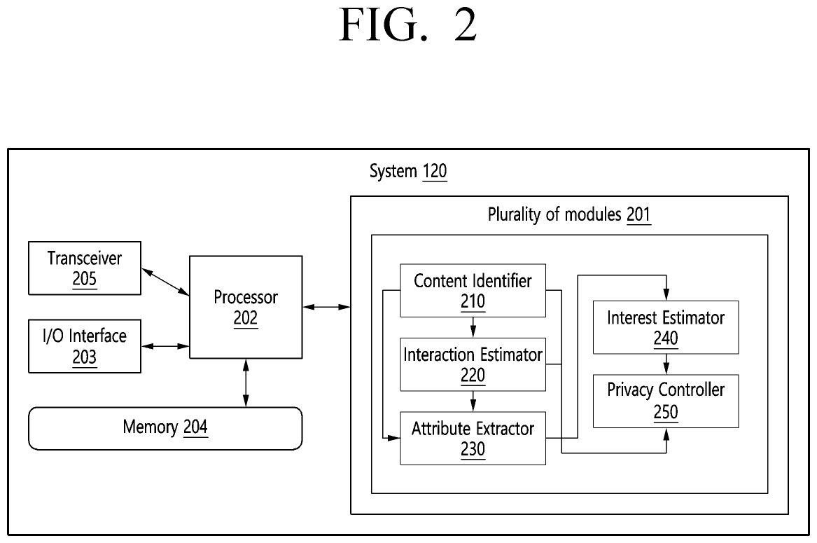

Reference is made to FIG. 2 which is a block diagram illustrating an example configuration of the system 120, according to various embodiments. The system 120 may include a plurality of modules (e.g., including various circuitry and/or executable program instructions) 201, a processor (e.g., including processing circuitry) 202, an Input/Output (I/O) interface (e.g., including I/O circuitry) 203, a memory 204, and a transceiver 205.

In an example embodiment, the processor 202 may be operatively coupled to each of the I/O interface 203, the plurality of modules 201, the transceiver 205, and the memory 204. In an embodiment, the processor 202 may include a graphical processing unit (GPU) and/or an Artificial Intelligence Engine (AIE). In an embodiment, the processor 202 may include at least one data processor for executing processes in virtual storage area network. The processor 202 may include specialized processing units such as, integrated system (bus) controllers, memory management control units, floating point units, graphics processing units, digital signal processing units, etc. In an embodiment, the processor 202 may include a central processing unit (CPU), a graphics processing unit (GPU), or both. The processor 202 may be one or more general processors, digital signal processors, application-specific integrated circuits, field-programmable gate arrays, servers, networks, digital circuits, analog circuits, combinations thereof, or other now known or later developed devices for analyzing and processing data. The processor 202 may execute a software program, such as code generated manually (e.g., programmed) to perform the desired operation. The processor 202 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor 202 may be disposed in communication with one or more input/output (I/O) devices via the I/O interface 203. In various embodiments, the processor 202 may communicate with the electronic device 110 using the I/O interface 203. In various embodiments, the I/O interface may be implemented within the electronic device 110. The I/O interface 203 may include various I/O circuitry and employ communication code-division multiple access (CDMA), high-speed packet access (HSPA+), global system for mobile communications (GSM), long-term evolution (LTE), WiMax, or the like, etc.

Using the I/O interface 203, the system 120 may communicate with one or more I/O devices. For example, the input device may be an antenna, microphone, touch screen, touchpad, storage device, transceiver, video device/source, etc. The output devices may be a video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The processor 202 may be disposed in communication with a communication network via a network interface. In an embodiment, the network interface may be the I/O interface 203. The network interface may connect to the communication network to enable connection of the system 120 with the electronic device 110 and/or outside environment. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 120 may communicate with other devices.

In various embodiments, the memory 204 may be communicatively coupled to the processor 202. The memory 204 may be configured to store data and instructions executable by the processor 202. In an embodiment, the memory 204 may be provided within electronic device 110. In an embodiment, the memory 204 may be provided via a cloud-based unit. In an embodiment, the memory 204 may communicate with the processor 202 via a bus within the system 120. In an embodiment, the memory 204 may be located remote from the processor 202, and may be in communication with the processor 202 via a network. The memory 204 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 204 may include a cache or random-access memory for the processor 202. In various examples, the memory 204 may be separate from the processor 202, such as a cache memory of a processor, the system memory, or other memory. The memory 204 may be an external storage device or database for storing data. The memory 204 may be operable to store instructions executable by the processor 202. The functions, acts or tasks illustrated in the figures or described may be performed by the programmed processor 202 for executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

In various embodiments, the plurality of modules 201 may be included within the memory 204. The memory 204 may further include a database to store data. The plurality of modules 201 may include a set of instructions (e.g., executable program instructions) that may be executed to cause the system 120, including, for example, the processor 202 of the system 120, to perform any one or more of the methods/processes disclosed herein. The plurality of modules 201 may be configured to perform the steps of the present disclosure using the data stored in the database. For instance, the plurality of modules 201 may be configured to perform the steps described in greater detail below with reference to FIGS. 8 and 9. In an embodiment, each of the plurality of modules 201 may include hardware which may be outside the memory 204. Further, the memory 204 may include an operating system for performing one or more tasks of the system 120, as performed by a generic operating system.

The transceiver 205 may be configured to receive and/or transmit signals to and from the electronic device 110. In an embodiment, a database may be configured to store the information as required by the plurality of modules 201 and the processor 202 to perform one or more functions as disclosed in FIGS. 8-9.

The plurality of modules 201 may include, but not limited to, a content identifier 210, an interaction estimator 220, an attribute extractor 230, an interest estimator 240, and a privacy controller 250. The plurality of modules 201 may be implemented by way of suitable hardware and/or software applications.

In various embodiments, at least one of the plurality of modules 201 may use an AI model. A function associated with AI may be performed through the non-volatile memory, the volatile memory, and the processor 202.

The processor 202 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule stored in the non-volatile memory or may employ a suitable artificial intelligence (AI) model executed from a server or a local memory module.

The AI model may include a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique may refer, for example, to a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, active learning and reinforcement learning. The processor 202 may perform pre-processing operations on the data to convert it into a form appropriate for use as an input for the artificial intelligence (AI) model.

Reasoning prediction may refer, for example, to a technique of logically reasoning and predicting by determining information and includes, e.g., knowledge-based reasoning, optimization prediction, preference-based planning, or recommendation.

Further, the present disclosure contemplates a non-transitory computer-readable medium that includes instructions or receives and executes instructions responsive to a propagated signal. Further, the instructions may be transmitted or received over the network via a communication port or interface or using a bus (not shown). The communication port or interface may be a part of the processor 202 or may be a separate component. The communication port may be created in software or may be a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the system 120 may be physical or may be established wirelessly. The network may alternatively be directly connected to a bus. For the sake of brevity, the architecture and standard operations of the memory 204, the processor 202, the transceiver 205, and the I/O interface 203 are not discussed in detail.

FIG. 2 further illustrates example operational flow associated with the plurality of modules 201. It is appreciated that the details described with reference to the plurality of modules 201 may be performed in conjunction with the processor 202 and the memory 204.

The content identifier 210 may be configured to identify content associated with a user using the electronic device 110. The content may be associated with various content types, such as, but not limited to, pictures, music, video, text, link, audio, and documents. The content may refer to one or more of the content types which will be interacted with by the user. In various embodiments, the electronic device 110 may include multiple view components such as ImageView, TextView, Video View, and the like. The view components may correspond to the content types. In various embodiments, the electronic device 110 may include event listeners associated with the view components to listen to, e.g., monitor user interactions. Accordingly, the content type currently being interacted with by the user may be determined.

The interaction estimator 220 may be configured to capture an optimal interaction indicative of interactions of the user with respect to each content type of the content. In an embodiment, the optimal interaction may be indicative of an interaction with the electronic device 110 and may be simply referred to as an “interaction”. The optimal interaction may be determined from a stream of interactions being continuously performed by the user. In non-limiting embodiments, the optimal interaction may include one or more of touch, physical buttons, gestures, voice commands, text input, navigation, application interactions, media controls, camera and multimedia, communication, notifications, security, settings, customization, file management, payments, accessibility, smart device control, gaming, screen recording, search, battery, power management, and emergency services.

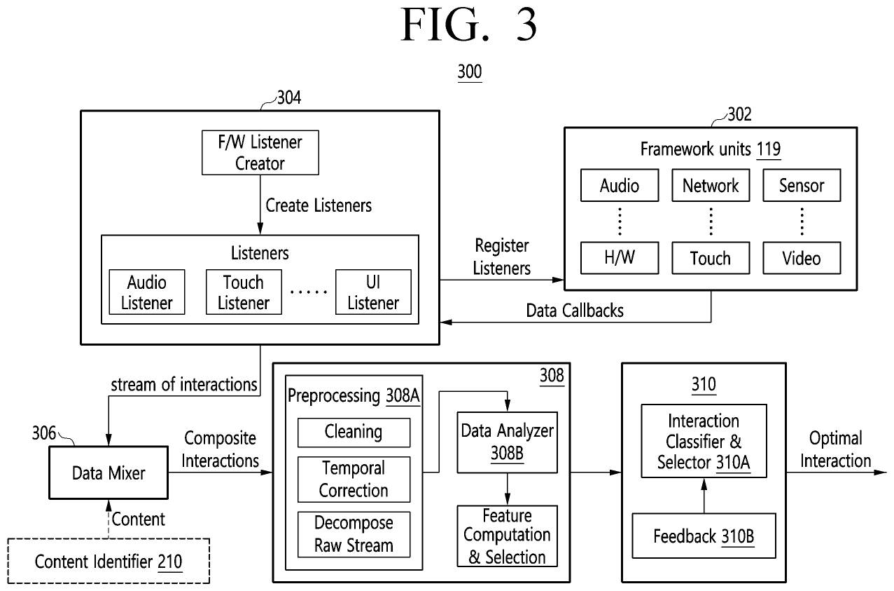

In an embodiment, the optimal interaction may be determined from the stream of interactions captured by the set of framework units 119, as described with reference to FIG. 3 which is a block diagram illustrating example operational flow 300 to determine the optimal interaction. As shown by block 302, the set of framework units 119 may be provided which include multiple framework units such as audio, network, location, biometric, sensor, hardware, touch, video, and the like. As shown by block 304, a set of listeners may be created and registered with the set of framework units 119. The set of listeners may correspond to the set of framework units 119. For example, the set of listeners may include audio listeners, touch listeners, user interface (UI) listeners, and the like.

The set of listeners may capture the stream of interactions based on data callbacks from the set of framework units 119. The stream of interactions may thus be received from the set of framework units 119 via data callbacks. Table 1 shows a non-limiting example of the stream of interactions being captured by the set of listeners and the set of framework units 119.

TABLE 1

| F/W | Type | Data |
|---|---|---|
| Audio | Pulse Code | Amplitude of Audio Waveforms |
| | Modulation | [ { 01100100, 10111010, 00101001 ... } ] |
| Audio | Advanced | Binary File (Hexadecimal Pairs) |
| | Audio | [ { FF, F1, 50, 80, 3E, 24 .... } ] |
| | Coding | |
| Touch | Tap | X,Y Coordinates |
| | | [{ 329, 446 } .. ] |
| Touch | Swipe | X,Y Coordinates |
| | | [ { 329, 446 } , { 123, 245} ... ] |
| H/W | Press | (KeyCode, KeyEvent) |
| H/W | Long Press | (KeyCode, KeyEvent) |

At block 306, composite interactions may be generated based on the content from the content identifier 210 and the received stream of interactions. In an embodiment, the interaction estimator 220 may comprise a data mixer sub-module configured to generate the composite interactions.

At block 308, the composite interactions may be provided to an interaction classifier model. The interaction classifier model processes the composite interactions to meaningful data which can be used to identify the user interactions. In an embodiment, the interaction classifier model may be a trained mathematical model. In an embodiment, the interaction classifier model may be stored in the memory 204. As shown in block 308, the processing of the composite interactions may include pre-processing 308A, data analyzing 308B, and feature computation and selection 308C. In an embodiment, the pre-processing may include data cleaning, temporal correction, and decomposing the raw stream.

At block 310, the optimal interaction (or interaction) may be selected based on the analysis of the composite interactions. The optimal interaction may refer to relevant and meaningful interactions that are happening in real-time. As shown in block 310A, the output from the block 308 may be processed to select the optimal interaction. In various embodiments, as depicted by 310B, a feedback loop may be provided to enhance the accuracy of the selection and classification of the optimal interaction. In various embodiments, the optimal interaction may include interactions with camera of the electronic device 110, touch screen interactions, hardware buttons (volume button, power button, home button, etc.), electronic device orientation, microphone, and other connected units (wearable controllers, stylus, etc.)

Referring again to FIGS. 1 and 2, the attribute extractor 230 may be configured to extract a set of attribute values based on the content from the content identifier 210 and the optimal interaction from the interaction estimator 220. The set of attribute values may be indicative of user behaviour patterns with respect to each content type. In non-limiting examples, the set of attribute values include values associated with interaction frequency, interaction context, content type frequency, content engagement time, interaction intensity, button interaction rate, historical data, user feedback, demographics, and the like.

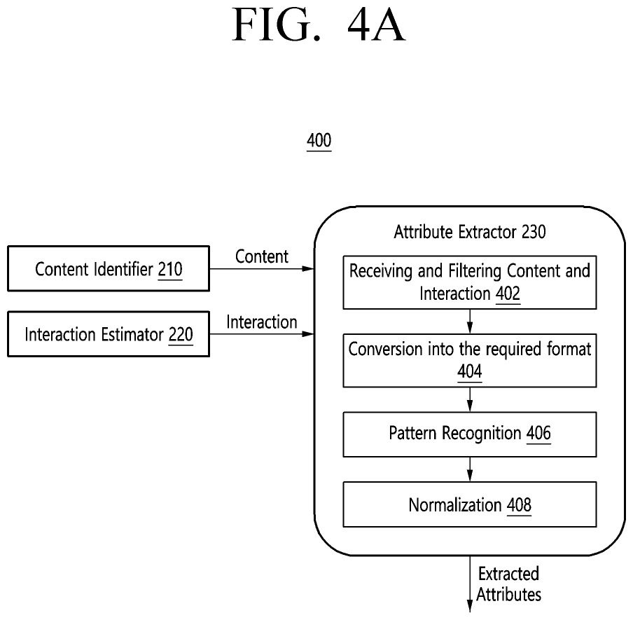

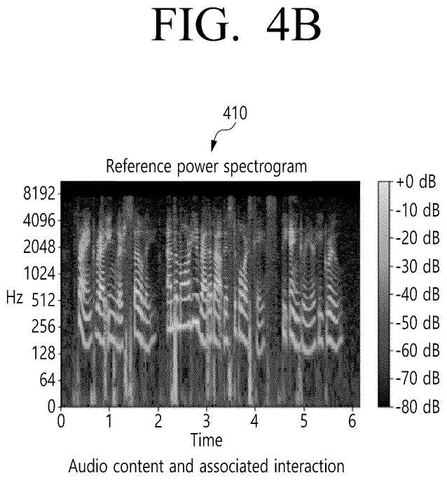

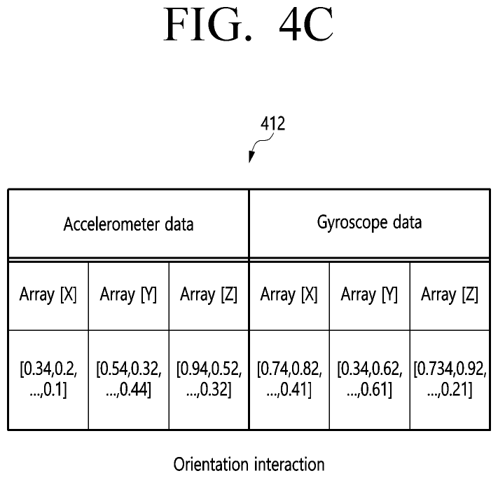

In an embodiment, the attribute extractor 230 may be configured to apply one or more pattern recognition techniques on the content from the content identifier 210 and the optimal interaction from the interaction estimator 220. Referring to FIG. 4A, an example operational flow 400 to extract the set of attribute values is depicted. At block 402, the content from the content identifier 210 and the optimal interaction from the interaction estimator 220 may be received and filtered by the attribute extractor 230. In an embodiment, filtered data may be generated at block 402. The filtering may include cleaning of the received data (content and optimal interaction), detecting anomalies, removing outliers, handling missing values, and removing corrupted data. In an embodiment, statistical techniques such as Z-square method may be utilized for anomalies detection.

At block 404, the attribute extractor 230 may be configured to convert the filtered data to a pre-defined format suitable for processing by pattern recognition techniques and other mathematical models (machine learning and artificial intelligence models), as will be described below.

At block 406, the pattern recognition techniques may be applied to the filtered data in the pre-defined format in order to determine the set of attribute values. The pattern recognition techniques may include, for instance, convolutional neural networks (CNN) and Recurrent Neural Networks (RNN).

In various embodiments, at block 408, data normalization techniques may be applied to the filtered data in the pre-defined format in order to reduce computations of the pattern recognition techniques. Accordingly, the set of attribute values may be extracted by the attribute extractor 230. FIGS. 4B and 4C illustrate an example set of attribute values extracted by the attribute extractor 230. Attribute values for audio content and the associated interaction is depicted by a spectrogram frame 410 while attribute values for orientation interaction is depicted by table 412 of orientation frame data.

Referring again to FIGS. 1 and 2, the interest estimator 240 may be configured to classify the content from the content identifier 210 based on the extracted set of attributes values from the attribute extractor 230. By virtue of the classification, the interest estimator 240 determines the sensitivity of the content as either of interest or of non-interest to the user interacting with the content. The interest estimator 240 may classify the content based on one or more of a plurality of estimation models. In an embodiment, the plurality of estimation models may be trained mathematical models stored in the memory 204. In an embodiment, at least one estimation model of the plurality of estimation models is a trained mathematical model.

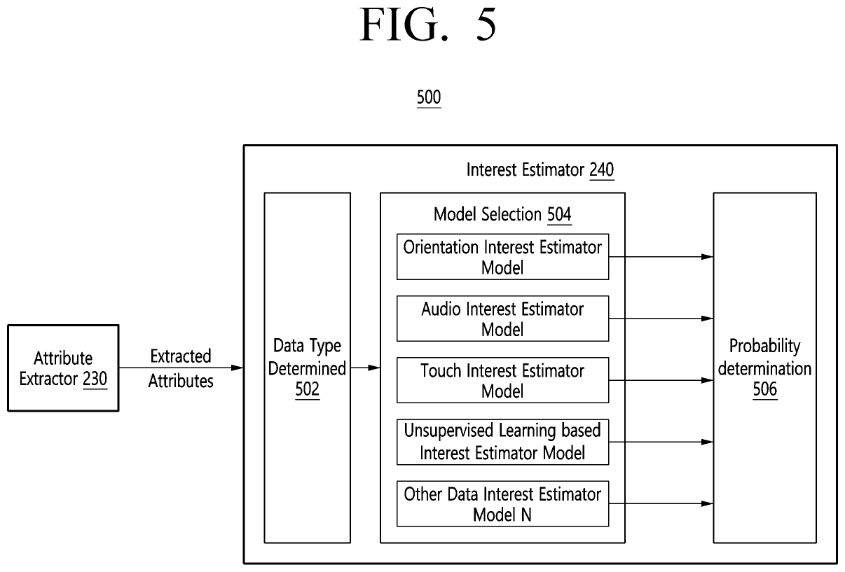

Referring to FIG. 5, an example operational flow 500 to classify the content is depicted. At block 502, the extracted set of attribute values are received by the interest estimator 540 and a data type associated with the set of attribute values is determined. At block 504, an estimation model from among the plurality of estimation models is determined based on the determined data type. At block 506, the interest estimator 240 determines a first probability value associated with sensitivity of the content being of interest and a second probability value associated with sensitivity of the content being of non-interest. For example, the interest estimator 240 determines whether the content has more probability of being of interest to the user or being of non-interest to the user. Based on the first probability value and the second probability value, the interest estimator 240 classifies the content as being of interest or non-interest to the user.

In an example embodiment, the content type may be audio and the system 120 may determine whether the user intended to be heard by the electronic device or not. In this example, intended to be heard refers to interest and not intended to be heard refers to non-interest (or not of interest). A non-limiting example of audio of non-interest may include user talking to another user and the electronic device 110 is in pocket of the user, a remote speaker is playing an audio not meant for the electronic device 110, random ambient sounds in the surroundings, etc. A non-limiting example of audio of interest may include the user talking to smart-assistant integrated with the electronic device 110, user talking to another user over phone call, user recording a video, user speaking to virtual users in online games, etc.

The audio may be captured and converted to a spectrogram image by applying Fast Fourier Transform (FFT) on the captured audio. The spectrogram image may indicate details of frequency composition of the captured audio over time. The spectrogram image may be provided as input to an estimation model, such as a CNN. The CNN may comprise multiple layers such as Conv2D layer, Max Pooling 2D layer, fully connected layers, softmax, and the like. In an embodiment, the Conv2D layer may learn features or patterns in the input by applying a set of learnable filters on the input. Relevant features from the input may thus be learned. In an embodiment, the Max Pooling 2D layer may uses a simple maximum function instead of a kernel to learn features. This layer takes a patch of activations in an original feature map and replaces them with the maximum activation in that patch. In an embodiment, the fully connected layers classify the data into two classes. In an embodiment, the softmax function transforms outputs of the fully connected layers into a probability distribution output in the range of 0 to 1, where the total sum equals to 1. Accordingly, probabilities of interest or non-interest of content can be determined. In various embodiments, the CNN may be trained based on back propagation technique in which gradients are applied to weights of the layers in the CNN till convergence.

In an example embodiment, the system 120 may determine whether the an orientation pattern made by the user is of interest or non-interest. In this example, the user may rotate the electronic device 110 in landscape mode to watch a video, thereby indicating that the orientation is of interest to the user. The orientation data captures may include accelerometer data and magnetometer data. The orientation data may be pre-processed to converted to a pandas data frame depicting shapes of 3D vectors and reducing the dimensionality using PCA. The data may be passed as input to a CNN model which may classify the data as of interest or non-interest to the user.

In various embodiments, the estimation model may be trained based on unsupervised learning technique, such as, a K-Means clustering model. In various embodiments, training of the estimation model includes providing the attribute values as input to the model. The input may be encoded with techniques such as label encoding, word2vec, etc. The input may be converted into a pandas data frame for dimensionality reduction. In an embodiment, the input may undergo principal component analysis (PCA) for dimensionality reduction. Further, the number of clusters may be inputted (here, the number of clusters may be 2—interest and non-interest). Further distance between PCA computed data points may be calculated. Further, the data points may be grouped based on a minimum distance and stability of the clusters may be determined. In case the clusters are unstable, then centroid may be re-calculated and feedback may be provided. By means of the training process as described above, a trained estimation model may be obtained with the number of clusters (e.g., 2 clusters).

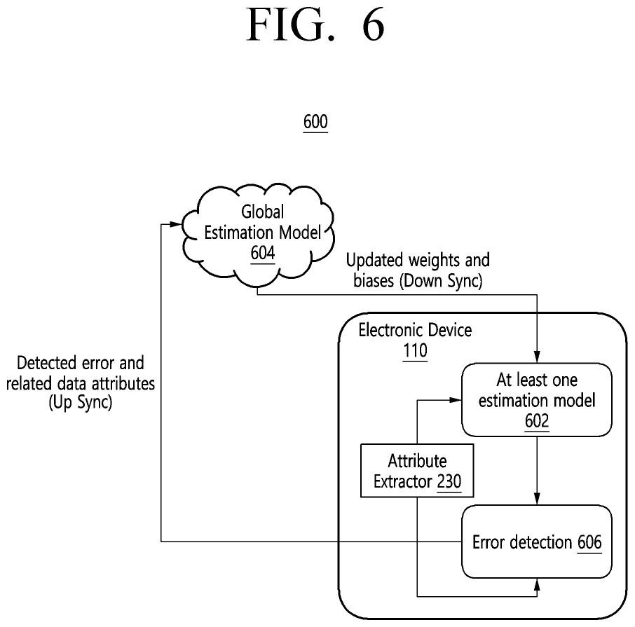

In various embodiments, at least one estimation model of the plurality of estimation models may be an on-device model and may be trained based on a global estimation model stored on a cloud-based server. Referring to FIG. 6, a block diagram illustrating an example hybrid model deployment 600 is illustrated. The at least one estimation model 602 may act as a distilled model with respect to the global estimation model 604. The at least one estimation model 602 may classify the content as of interest or non-interest to the user. The at least one estimation model 602 may be configured to adjust the corresponding weights and biases based on parameters provided by the global estimation model 604. The global estimation model 604 may be a pre-trained model which is also configured to undergo continuous training based on feedback and errors received from the electronic device 110 where the at least one estimation model 602 is implemented.

In use, the at least one estimation model 602 may take inputs from the attribute extractor 230 and predict probability values associated with the content being of interest or non-interest to the user. The at least one estimation model 602 may further provide a confidence score corresponding to the predictions. In case the confidence scores are low or in case of contradictory feedback from the user, error feedback may be generated at block 606 and sent to the global estimation model 604 along with the related attribute values. The global estimation model 604 may retrain based on the error feedback to re-adjust its weights and biases. The re-adjustments are then propagated to the at least one estimation model to improve the performance. Thus, a hybrid model deployment may be achieved to provide a smaller size model on-device.

Referring again to FIGS. 1 and 2, the privacy controller 250 may be configured to control access to the content for the one or more applications 111 based on the classified content being of interest or non-interest to the user. The one or more applications 111 may include third party applications which may track the content and the interactions of the user with the content. However, in case the sensitivity of the content is of interest to the user, then it is essential that the access to the content by the one or more applications 111 is restricted or completely blocked. The privacy controller 250 may thus determine possible tracking methods by which the content can be tracked by the one or more applications 111 and control the access to the content by means of the framework units 119.

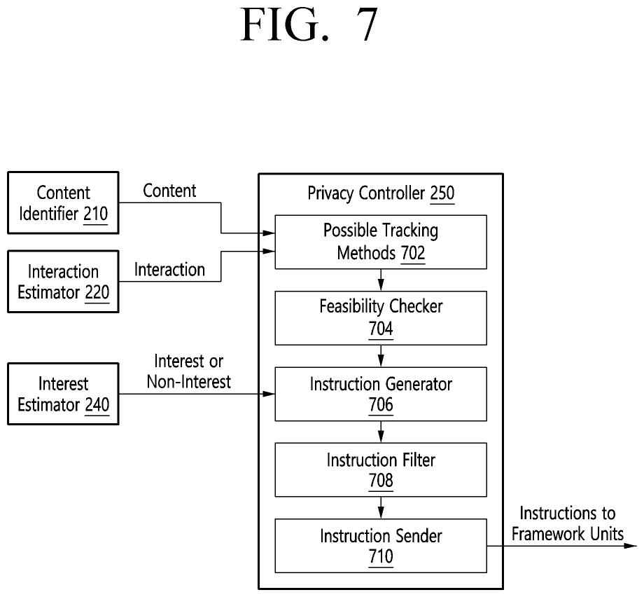

FIG. 7 is a block diagram illustrating example operational flow to control access to the content by the privacy controller 250 according to various embodiments. The privacy controller 250 may receive the content and the optimal interaction from the content identifier 210 and the interaction estimator 220 respectively. At block 702, the privacy controller 250 may be configured to determine, based on the content and the optimal interaction, a plurality of possible tracking methods utilized by the one or more applications 111 to track the content. The plurality of possible tracking methods may refer to detection methods that the one or more applications 111 may take to detect user interactions. In an embodiment, information regarding the plurality of possible tracking methods may be pre-stored in the memory 204.

At block 704, the privacy controller 250 is configured to select one or more feasible tracking methods from among the plurality of possible tracking methods. For example, not all of the plurality of possible tracking methods may be feasible in view of the content and the optimal interaction. The privacy controller 250 checks which tracking methods may be feasible and work on the electronic device 110, thereby decreasing the amount of generated access instructions to control access to the content.

At block 706, the privacy controller 250 may be configured to generate the access instructions for the framework units 119. The privacy controller 250 may receive inputs from the interest estimator 240 to generate the instructions. The access instructions may be based on the sensitivity of the content, in that, if the content is determined as being of interest to the user, then the access instructions may be indicative of blocking access to the content.

At block 708, the privacy controller 250 may filter the generated instructions to generate sub-lists pertaining to the respective framework units 119. At block 710, the privacy controller 250 may send the generated access instructions to corresponding framework units from among the set of framework units 119 to control the access to the content by the one or more applications. Accordingly, when the content is sensitive content of interest to the user, then the one framework units may block access for the one or more applications 111.

Taking an example of a user capturing a screenshot on the electronic device 110, the content may include visible content being consumed by the user, such as, social media content. The user may proceed to capture a screenshot which indicates the interactions of the user with the content. The interactions may include pressing of hardware keys, long press of touch, extended screen time, etc. The privacy controller 250 may determine the plurality of possible tracking methods to track the screenshot. In various embodiments, the plurality of possible tracking methods may include overriding of application programming interfaces (APIs) by the one or more applications to track user interactions, monitoring notification channels, specifically created callback functions, access to files and media in the electronic device 110, clipboard access, etc.

The privacy controller 250 may select the feasible tracking methods out of the plurality of tracking methods. For example, the feasible tracking methods may include notification channels and key-event callbacks. Based on the feasible tracking methods and the sensitivity of the content being of interest to the user, the privacy controller 250 may generate the access instructions which may be sent to the relevant framework units 119. For example, the access instructions may be sent to hardware framework unit, UI framework unit, and application framework unit. The access instructions may include blocking of hardware button callbacks, sandboxing notifications, etc. Accordingly, access to the content being captured via screenshot may be prevented or blocked by the system 120.

Taking another example of a user capturing rotating the screen of the electronic device 110, the content may include visible content being consumed by the user, such as, playing a game, watching a video, showing video to a friend, recording a video, etc. The user may proceed to rotate the electronic device which indicates the interactions of the user with the content. The interactions may include device motion or pressing or an accessibility button. The privacy controller 250 may determine the plurality of possible tracking methods to track the orientation change. In various embodiments, the plurality of possible tracking methods may include orientation callbacks, notification channels, rotation vector sensors, accessibility service, etc.

The privacy controller 250 may select the feasible tracking methods out of the plurality of tracking methods. For example, the feasible tracking methods may include orientation callbacks and rotation vector sensors. Based on the feasible tracking methods and the sensitivity of the content being of interest to the user, the privacy controller 250 may generate the access instructions which may be sent to the relevant framework units 119. For example, the access instructions may be sent to hardware framework unit, UI framework unit, and application framework unit. The access instructions may include blocking of orientation callbacks and restricting use of rotation vector sensors. Accordingly, access to the content being watched by the user by rotating the electronic device 110 may be prevented/blocked by the system 120.

FIG. 8 is a flowchart illustrating an example method 800 for controlling framework units 119 to access content on the electronic device 110, according to various embodiments. In an embodiment, the operations of the method 800 may be performed by the system 120, for instance, by the processor 202 of the system 120 in conjunction with the plurality of modules 201 and the memory 204, which may be integrated within the electronic device 110 or provided separately and are operatively coupled.

At S802, the method 800 includes capturing an optimal interaction (e.g., interaction) indicative of an interaction of a user with respect to each content type of the content.

At S804, the method 800 includes extracting a set of attribute values based on the content and the optimal interaction, wherein the set of attribute values is indicative of user behaviour patterns with respect to each content type.

At S806, the method 800 includes classifying the content based on the extracted set of attributes values, wherein the classification determines the sensitivity of the content as either of interest or of non-interest.

At S808, the method 800 includes controlling access to the content for one or more applications associated with the electronic device based on the classified content being one of interest or non-interest to the user.

FIG. 9 is a flowchart illustrating an example method 900 for dynamically restricting applications 111 from accessing content on the electronic device 110, according to various embodiments. In an embodiment, the operations of the method 900 may be performed by the system 120, for instance, by the processor 202 of the system 120 in conjunction with the plurality of modules 201 and the memory 204, which may be integrated within the electronic device 110 or provided separately and are operatively coupled.

At S902, the method 900 includes capturing user interactions with content types, the captured user interactions forming user behavior patterns on the attributes indicative of responses of a user to each content type.

At S904, the method 900 includes training an on-device machine learning model based on the content types and captured interactions to extract attributes specific to the user.

At S906, the method 900 includes classifying content based on extracted attributes, wherein the classification determines the sensitivity of the content as either of interest or of non-interest.

At S908, the method 900 includes capturing user behavior when interacting with new content on the electronic device.

At S910, the method 900 includes predicting, using the trained on-device machine learning model, whether the interaction with new content resulting interest or non-interest of user in content.

At S912, the method 900 includes controlling access to the content by the applications on the electronic device.

While the above discussed steps in FIGS. 8 and 9 are illustrated and described in a given sequence, the steps may occur in variations to the sequence in accordance with various embodiments. Further, a detailed description related to the various steps of FIGS. 8 and 9 is already covered in the description related to FIGS. 1, 2, 3, 4, 5, 6 and 7 and is not repeated here for the sake of brevity.

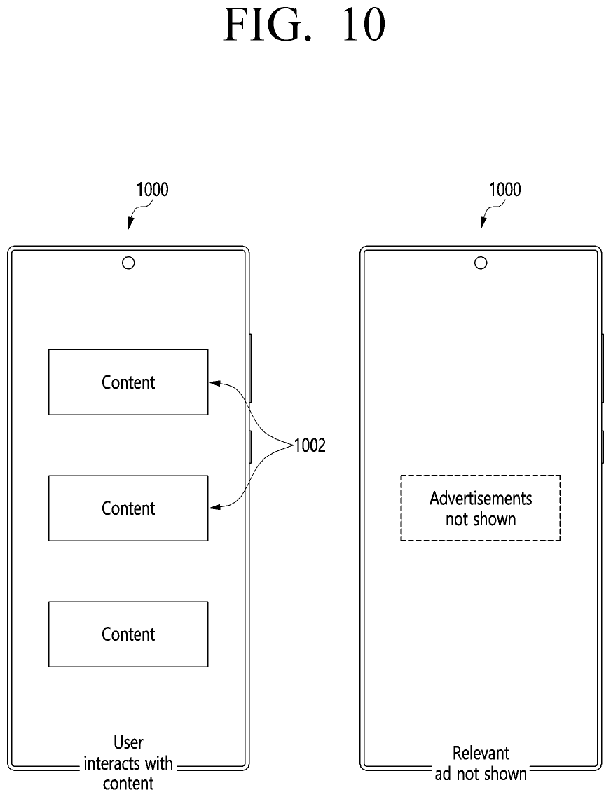

FIG. 10 is a diagram illustrating an example use case scenario for the system 120 for controlling access to the content, according to various embodiments. FIG. 10 illustrates an electronic device 1000 being utilized by a user to view social media content on an application. The user may scroll on the user interface of the electronic device 1000 to view various social media content 1002. Further, the user may perform other actions such as capturing a screenshot, viewing content for a long time, long tap on screen, etc. As per conventional techniques, the user interaction with the social media content 1002 may be tracked and based on the content being consumed by the user, relevant advertisements may be shown to the user. However, with the presently disclosed system and method, the access to the social media content is blocked and third party applications are unable to track the user interactions and content. The user privacy is thus maintained.

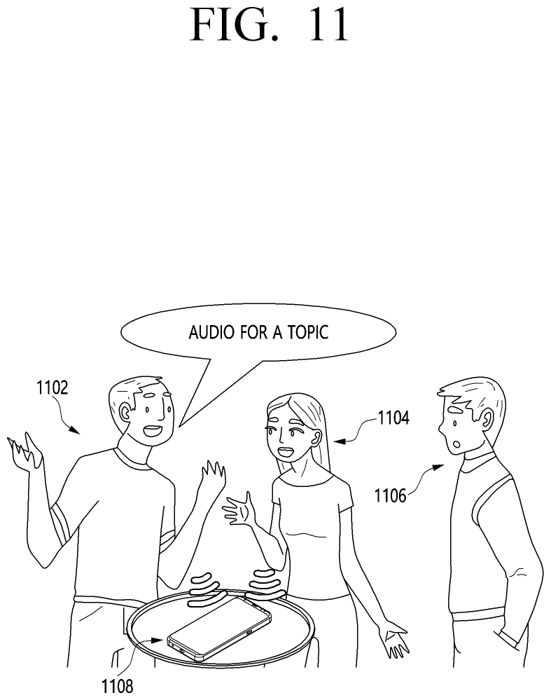

FIG. 11 is a diagram illustrating an example use case scenario for the system 120 for controlling access to the content, according to various embodiments. FIG. 11 shows a user 1102 talking with other users 1104, 1106 regarding a particular topic. The topic may be, for instance, a travel plans, shopping related discussion, entertainment related discussion, and the like. The electronic device 1108 of the user 1102 may listen to the user 1102 even though the user is not intending to give audio input to the electronic device 1108. As per conventional techniques, the applications on the electronic device 1108 track user's not-intended-to-phone audio and presents advertisements on the topic to the user. However, with the presently disclosed system and method, the user's not-intended-to-phone audio is not tracked and privacy breach is prevented or reduced.

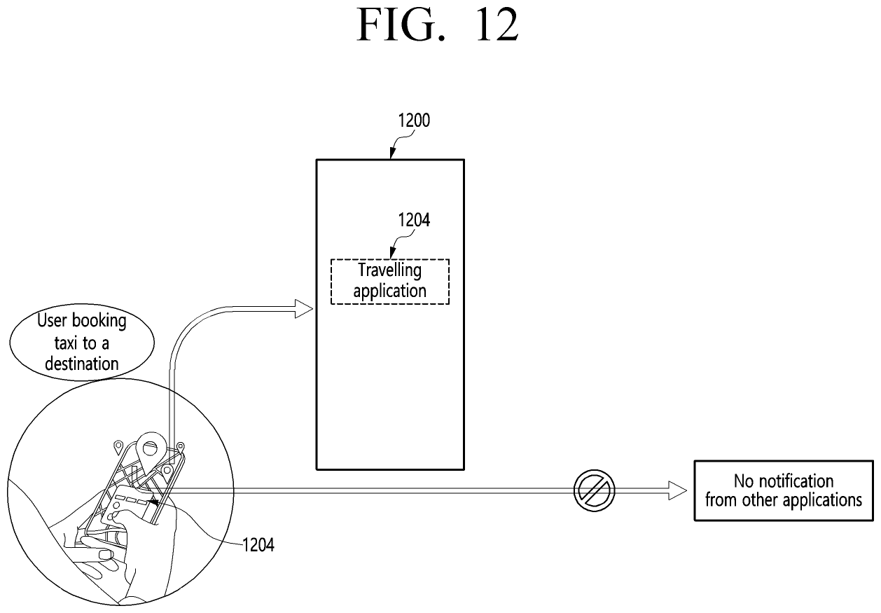

FIG. 12 is a diagram illustrating an example use case scenario for the system 120 for controlling access to the content, according to various embodiments. FIG. 12 illustrates an electronic device 1200 being utilized by a user to view content on an application 1204. In the illustrated example, the user may be looking to book a taxi to a destination via one application 1204 of multiple travelling applications in the electronic device 1200. As per conventional techniques, the interaction of the user with the travelling application may be tracked and another travelling application may trigger a notification for the user for booking a taxi via the another travelling application instead. However, with the presently disclosed system and method, the access to user interest data (booking action for travel to a destination) is blocked for other travelling applications.

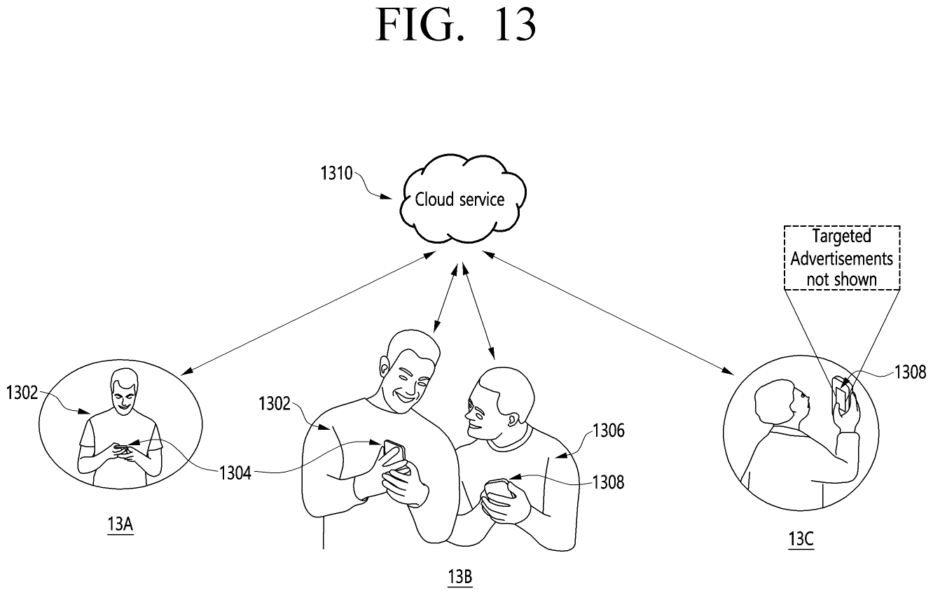

FIG. 13 is a diagram illustrating an example use case scenario for the system 120 for controlling access to the content, according to various embodiments. FIG. 13 illustrates example scenarios 13A, 13B and 13C in which a user 1302 accessing an electronic device 1304, such as user's mobile phone, to view content, as shown by 13A. For instance, the user 1302 may view ticket prices for an entertainment event of a particular artist. The user 1302 may access different websites through the electronic device 1304 to check ticket prices. As shown by 13B, the user 1302 may show the details on the electronic device 1304 to a friend 1306. For instance, the user 1302 may change the orientation of the electronic device 1304 so as to face the friend 1306 standing next to the user 1302. A cloud service 1310 may be tracking the interest of the user 1302 by analyzing the user interactions associated with the electronic device 1304. The user interaction may include change in orientation of the electronic device 1304 while showing the content to the friend 1306. As per conventional techniques, the interaction of the user 1302 with the electronic device 1304 may be tracked and the friend 1306 may also be shown targeted advertisements on the friend's device 1308, the targeted advertisements being related to the entertainment event of the particular artist. However, with the presently disclosed system and method, as shown by 13C, the user interactions are not tracked and no targeted advertisements are shown, thereby preventing and/or reducing privacy breach.

In various examples, tracking of geolocations of users is prevented/blocked by the presently disclosed method and system. Further, monitoring of common interests of two or more users is blocked. Moreover, detection of nearby devices can be prevented or blocked by blocking access of location and wireless signals (Bluetooth, Wi-Fi, etc.).

The present disclosure provides for various technical advancements based on the key features discussed above. The presently disclosed method and system enable dynamic control of access to the content and user interests. In case content of user interest is detected, then the access to the content is restricted for the applications. Moreover, the access control may be user controlled or automatic. As a result, user privacy is maintained while the user interacts with the content via the applications.

Further, user's interest data is safeguarded based on real time user interactions. In other words, the method and system enable safeguarding of user's interest data and/or content that is generated based on real time user interaction with a content of a defined content type in an application belonging to a defined application category from third-party app interactions/actions on the concept of interest leak of the user to prevent and/or reduce privacy breaches. Accordingly, user's privacy is not breached when the third-party applications try to access real time generated interest data and/or content to infer user interests.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for controlling framework units for accessing content on an electronic device, the method comprising:
capturing an interaction indicative of an interaction of a user with respect to each content type of the content;
extracting a set of attribute values based on the content and the optimal interaction, wherein the set of attribute values is indicative of user behaviour patterns with respect to each content type;
classifying the content based on the extracted set of attributes values, wherein the classification determines a sensitivity of the content as either of interest or not of interest; and
controlling access to the content for one or more applications associated with the electronic device based on the classified content being one of interest or not of interest to the user.

2. The method as claimed in claim 1, wherein capturing the interaction comprises:
receiving, from a set of framework units associated with the electronic device, a stream of interactions associated with the electronic device;
generating composite interactions based on the received stream of interactions and the content;
analysing the composite interactions based on an interaction classifier model; and
selecting the interaction based on the analysis of the composite interactions.

3. The method as claimed in claim 1, wherein extracting the set of attribute values comprises:
filtering the content and the interaction to generate filtered data, wherein filtering the content and the interaction comprises removal of outliers, anomalies, and corrupted data;
converting the filtered data to a specified format; and
extracting the set of attribute values from the filtered data in the specified format based on one or more pattern recognition techniques.

4. The method as claimed in claim 1, wherein classifying the content comprises:
determining a data type associated with set of attribute values;
selecting an estimation model from among a plurality of estimation models based on the determined data type;
determining, based on the selected estimation model, a first probability value associated with sensitivity of the content being of interest and a second probability value associated with sensitivity of the content being not of interest; and
classifying the content based on the first probability value and the second probability value.

5. The method as claimed in claim 4, wherein at least one estimation model of the plurality of estimation models comprises a trained mathematical model stored on the electronic device, and wherein the at least one estimation model is configured to be trained based on a global estimation model stored on a cloud-based server.

6. The method as claimed in claim 1, wherein controlling access to the content comprises:
determining, based on the content and the interaction, a plurality of possible tracking methods utilized by the one or more applications to track the content;
selecting one or more feasible tracking methods from among the plurality of possible tracking methods;
based on the content being determined to be of interest to the user, generating access instructions indicative of blocking access to the content; and
sending the generated access instructions to corresponding framework units from among a set of framework units to control the access to the content by the one or more applications

7. The method as claimed in claim 1, wherein the content type is associated with one or more of pictures, music, video, text, link, audio, document, and visual action elements.

8. The method as claimed in claim 1, wherein the interaction is associated with one or more of touch, physical buttons, gestures, voice commands, text input, navigation, application interactions, media controls, camera and multimedia, communication, notifications, security, settings, customization, file management, payments, accessibility, smart device control, gaming, screen recording, search, battery, power management, and emergency services.

9. A system for controlling framework units for accessing content on an electronic device, the system comprising:
a memory configured to store a plurality of modules in the form of programmable instructions;
at least one processor, comprising processing circuitry, communicatively coupled to the memory, at least one processor, individually and/or collectively, configured to execute the programmable instructions associated with the plurality of modules, the plurality of modules comprising:
an interaction estimator configured to capture an interaction indicative of an interaction of a user with respect to each content type of the content;
an attribute extractor configured to extract a set of attribute values based on the content and the interaction, wherein the set of attribute values is indicative of user behaviour patterns with respect to each content type;
an interest estimator configured to classify the content based on the extracted set of attributes values, wherein the classification determines the sensitivity of the content as either of interest or not of interest; and
a privacy controller configured to control access to the content for one or more applications associated with the electronic device based on the classified content being one of interest or not of interest to the user.

10. The system as claimed in claim 9, wherein to capture the optimal interaction, the interaction estimator is configured to:
receive, from a set of framework units associated with the electronic device, a stream of interactions associated with the electronic device;
generate composite interactions based on the received stream of interactions and the content;
analyse the composite interactions based on an interaction classifier model; and
select the interaction based on the analysis of the composite interactions

11. The system as claimed in claim 9, wherein to extract the set of attribute values, the attribute extractor is configured to:
filter the content and the interaction to generate filtered data, wherein filtering the content and the interaction comprises removal of outliers, anomalies, and corrupted data;
convert the filtered data to a specified format; and
extract the set of attribute values from the filtered data in the specified format based on one or more pattern recognition techniques.

12. The system as claimed in claim 9, wherein to classify the content, the interest estimator is configured to:
determine a data type associated with set of attribute values;
select an estimation model from among a plurality of estimation models based on the determined data type;
determine, based on the selected estimation model, a first probability value associated with sensitivity of the content being of interest and a second probability value associated with sensitivity of the content being not of interest; and
classify the content based on the first probability value and the second probability value.

13. The system as claimed in claim 9, wherein at least one estimation model of the plurality of estimation models comprises a trained mathematical model stored on the electronic device, and wherein the at least one estimation model is configured to be trained based on a global estimation model stored on a cloud-based server.

14. The system as claimed in claim 9, wherein controlling access to the content is configured to:
determine, based on the content and the interaction, a plurality of possible tracking methods utilized by the one or more applications to track the content;
select one or more feasible tracking methods from among the plurality of possible tracking methods;
based on the content being determined to be of interest to the user, generate access instructions indicative of blocking access to the content; and
send the generated access instructions to corresponding framework units from among a set of framework units to control the access to the content by the one or more applications

15. A method for dynamically restricting applications from accessing content in an electronic device, the method comprising:
capturing user interactions with content types, the captured user interactions forming user behavior patterns on the attributes indicative of responses of a user to each content type;
training an on-device machine learning model based on the content types and captured interactions to extract attributes specific to the user;
classifying content based on extracted attributes, wherein the classification determines the sensitivity of the content as either of interest or not of interest;
capturing user behavior when interacting with new content on the electronic device;
predicting, using the trained on-device machine learning model, whether the interaction with new content resulting interest or not of interest to user in content; and
controlling access to the content by the applications on the electronic device.

16. The method as claimed in claim 15, wherein the capturing is performed by a first monitoring service and a second monitoring services run by the applications and the electronic device respectively.

17. The method as claimed in claim 15, wherein based on the user interacting with the content on the applications, one of the first monitoring service running in the applications monitors users' interactions or the second monitoring service running in the electronic device monitors user interactions.

18. A system for dynamically restricting applications from accessing content in an electronic device, the system comprising:
a memory configured to store a plurality of modules in the form of programmable instructions;
at least one processor, comprising processing circuitry, communicatively coupled to the memory, at least one processor, individually and/or collectively, configured to execute the programmable instructions associated with the plurality of modules, the plurality of modules comprising:
an interaction estimator configured to capture user interactions with content types, the captured user interactions forming user behavior patterns on the attributes indicative of responses of a user to each content type;
an interaction estimator configured to trained an on-device machine learning model based on the content types and captured interactions to extract attributes specific to the user;
an interaction estimator configured to classify content based on extracted attributes, wherein the classification determines the sensitivity of the content as either of interest or not of interest;
an interaction estimator configured to capture user behavior when interacting with new content on the electronic device;
an interaction estimator configured to predict, using the trained on-device machine learning model, whether the interaction with new content resulting interest or not of interest to user in content; and
an interaction estimator configured to control access to the content by the applications on the electronic device.

19. The system as claimed in claim 18, wherein the capturing is configured to perform by a first monitoring service and a second monitoring services run by the applications and the electronic device respectively.

20. The system as claimed in claim 18, wherein based on the user interacting with the content on the applications, one of the first monitoring service running in the applications monitors users' interactions or the second monitoring service running in the electronic device monitors user interactions.
